(19) United States
(12) Patent Application Publication
(10) Pub. No.: US 2017/0336918 A1
(43) Pub. Date: Nov. 23, 2017

(54) TOUCH-SENSING DEVICES USING MINIMUM DEPTH-VALUE SURFACE CHARACTERIZATIONS AND ASSOCIATED METHODS

(71) Applicant: Intel Corporation, Santa Clara, CA (US)

(72) Inventors: David R. Holman, Brampton (CA); Kip C. Killpack, Beaverton, OR (US); Brandon Gavino, Beaverton, OR (US); Vinay K. Nooji, Hillsboro, OR (US); Abhay A. Dharmadhikari, Portland, OR (US); Vijay M. Rao, Hillsboro, OR (US)

(73) Assignee: Intel Corporation, Santa Clara, CA (US)

(21) Appl. No.: 15/161,279

(22) Filed: May 22, 2016

(51) Int. Cl. G06F 3/042; G06F 3/041

(52) U.S. Cl. CPC G06F 3/0421; G06F 3/0418

(57) ABSTRACT

Devices for sensing touch on a surface using a minimum depth-value surface characterization, including associated methods, are disclosed and described.

### BACKGROUND

Input devices for computer systems vary widely, ranging from traditional mechanical devices such as mice, keyboards, trackballs, styli, and the like, to nontraditional devices, such as gesture detection, and neural array monitoring. One developing technology utilizes image sensors that are capable of capturing depth or distance data to track a user's movements, including body movements, hand and finger movements, and the like. Additionally, such sensors have been used to detect the touch of a user against a flat surface.

### BRIEF DESCRIPTION OF THE DRAWINGS

Features and advantages of technology embodiments will be apparent from the detailed description which follows, taken in conjunction with the accompanying drawings, which together illustrate, by way of example, embodiment features; and, wherein:

FIG. 1 is a graphical representation of data in accordance with an embodiment of the present disclosure;

FIG. 2 is a side view of a user's finger in a touch window in accordance with an embodiment of the present disclosure;

FIG. 3 is a block diagram of an electronic device in accordance with an embodiment of the present disclosure;

FIG. 4 is diagram of steps of a method in accordance with an embodiment of the present disclosure;

FIG. 5 is a block diagram of an electronic device in accordance with an embodiment of the present disclosure; and

FIG. 6 is diagram of steps of a method in accordance with an embodiment of the present disclosure.

Reference will now be made to the exemplary embodiments illustrated, and specific language will be used herein to describe the same. It will nevertheless be understood that no limitation on disclosure scope is thereby intended.

### DESCRIPTION OF EMBODIMENTS

Before the disclosed technology embodiments are described, it is to be understood that this disclosure is not limited to the particular structures, process steps, or materials disclosed herein, but is extended to equivalents thereof as would be recognized by those ordinarily skilled in the relevant arts. It should also be understood that terminology employed herein is used for the purpose of describing particular examples or embodiments only and is not intended to be limiting. The same reference numerals in different drawings represent the same element. Numbers provided in flow charts and processes are provided for clarity in illustrating steps and operations and do not necessarily indicate a particular order or sequence.

Furthermore, the described features, structures, or characteristics can be combined in any suitable manner in one or more embodiments. In the following description, numerous specific details are provided, such as examples of layouts, distances, network examples, etc., to provide a thorough understanding of various embodiments. One skilled in the relevant art will recognize, however, that such detailed embodiments do not limit the overall inventive concepts articulated herein, but are merely representative thereof.

As used in this written description, the singular forms “a,” “an” and “the” include support for plural referents unless the context clearly dictates otherwise. Thus, for example, reference to “a bit line” includes support for a plurality of such bit lines.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the compositions nature or characteristics would be permissible if present under the “consisting essentially of” language, even though not expressly recited in a list of items following such terminology. When using an open ended term in this written description, like “comprising” or “including,” it is understood that direct support should be afforded also to “consisting essentially of” language as well as “consisting of” language as if stated explicitly and vice versa.

“The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

As used herein, “enhanced,” “improved,” “performance-enhanced,” “upgraded,” and the like, when used in connection with the description of a device or process, refers to a characteristic of the device or process that provides measurably better form or function as compared to previously known devices or processes. This applies both to the form and function of individual components in a device or process, as well as to such devices or processes as a whole.

As used herein, “coupled” refers to a relationship of electrical or physical connection or attachment between one item and another item, and includes relationships of either direct or indirect connection or attachment. Any number of items can be coupled, such as materials, components, structures, layers, devices, objects, etc. As used herein, “directly coupled” refers to a relationship of electrical or physical connection or attachment between one item and another item where the items have at least one point of direct physical contact or otherwise touch one another. For example, when one layer of material is deposited on or against another layer of material, the layers can be said to be directly coupled.

Objects or structures described herein as being “adjacent to” each other may be in physical contact with each other, in close proximity to each other, or in the same general region or area as each other, as appropriate for the context in which the phrase is used.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint. However, it is to be understood that even when the term “about” is used in the present specification in connection with a specific numerical value, that support for the exact numerical value recited apart from the “about” terminology is also provided.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 1.5, 2, 2.3, 3, 3.8, 4, 4.6, 5, and 5.1 individually.

This same principle applies to ranges reciting only one numerical value as a minimum or a maximum. Furthermore, such an interpretation should apply regardless of the breadth of the range or the characteristics being described.

Reference throughout this specification to “an example” means that a particular feature, structure, or characteristic described in connection with the example is included in at least one embodiment. Thus, appearances of the phrases “in an example” in various places throughout this specification are not necessarily all referring to the same embodiment.

### Example Embodiments

An initial overview of technology embodiments is provided below and specific technology embodiments are then described in further detail. This initial summary is intended to aid readers in understanding the technology more quickly, but is not intended to identify key or essential technological features, nor is it intended to limit the scope of the claimed subject matter.

The presently disclosed subject matter relates to devices, systems, and methods for detecting a touch event on a touch surface using light reflection. The detection of touch using light-based systems can be challenging, particularly on passive surfaces. For example, when an object such as a fingertip approaches the surface, the geometry of the object merges with the surface, making discernment difficult. One technique for addressing this problem is to interpret finger contact at a physical offset from the surface. As a touch event will be triggered by a system before the finger actually contacts the surface, the distance of this physical offset can affect usability of the system.

One technique that can be employed to reduce the offset involves characterizing each depth data point with a per-pixel histogram that is calculated over a motionless scene. Minimum and maximum distance thresholds that define finger contact are referenced from a histogram bin value. The bin value is determined by inspecting the histogram of each point, from least depth to greatest depth, and identifying the depth value in the histogram that is above a set threshold. It is noted, however, that this technique relies on a non-normal distribution of the depth data, and many three-dimensional (3D) imagers' depth data follow a normal distribution.

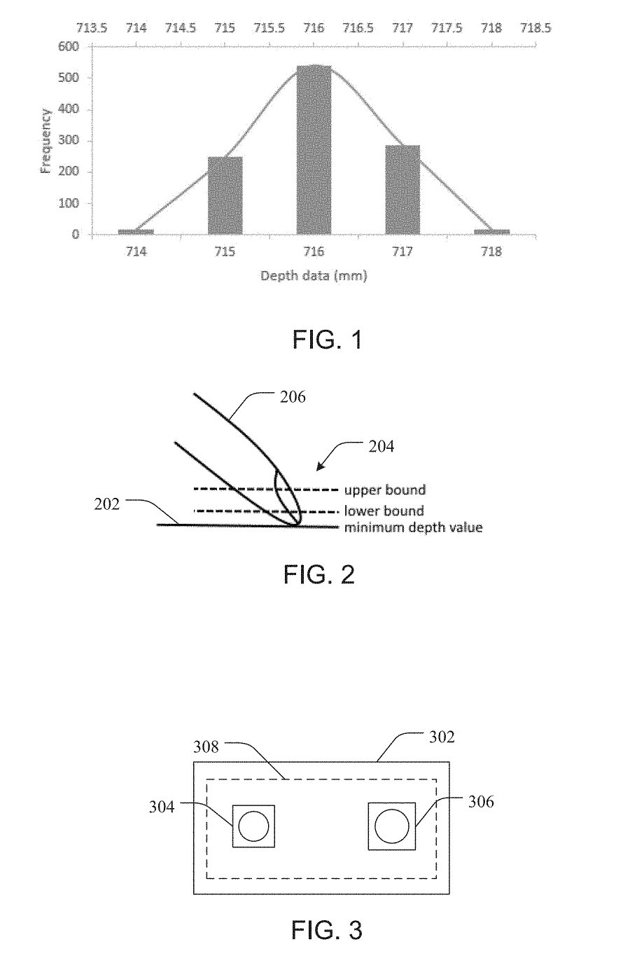

In one example embodiment, a scene such as a touch surface is characterized by calculating a minimum depth value for points on the touch surface over time. It is noted that the terms “depth” and “distance” can be used interchangeably, unless the context clearly indicates otherwise. Using data following a per point normal distribution, a minimum depth value that characterizes each surface point can be recorded, in some examples, in real-time. Given a depth data stream and motionless scene, in one non-limiting example this measurement is the minimum recorded distance from the surface of a given pixel in the imager to a point on the touch surface corresponding to (i.e. spatially aligned with) that pixel. As the minimum distance falls on the left tail of the depth data's distribution, the value of the minimum distance approximates the negative third standard deviation of the distribution (see FIG. 1). FIG. 1 shows a non-limiting example of a histogram of representative depth data from an imager recording a minimum distance or depth to a point on the touch surface of 714 mm. As such, 714 mm is an approximation of the negative third standard deviation of the distribution.

The minimum distance provides a reference point to establish a physical window centered at each point on the touch surface that is used to detect touch events at the touch surface. Thus, an object entering the touch window, such as a finger for example, would represent a touch event at the touch surface. As is shown in FIG. 2, once the minimum depth value 202 for a touch surface point is recorded, the touch window 204 is established having an upper bound and a lower bound. In one example, the lower bound is established by subtracting a minimum window value from the minimum depth value measurement and the upper bound is established by subtracting a maximum window value from the minimum depth value measurement. A user's finger 206 is shown within the touch window 204, thus causing a touch event on the touch surface.

In one example embodiment, as is shown in FIG. 3, a touch-sensing device 302 can include an active infrared (IR) projector 304 and an IR imager 306. The IR imager 306 comprises a plurality of pixels positioned to receive reflected IR light from the IR projector 304. In other words, the IR imager 306 is positioned to receive IR light generated by the IR projector 304 that is reflected off of the touch surface. One example configuration orients the IR projector 304 and the IR imager 306 in a common direction. In one example, the device can include a visible light image sensor. In another example, the IR imager is at least two IR imagers spaced apart from one another.

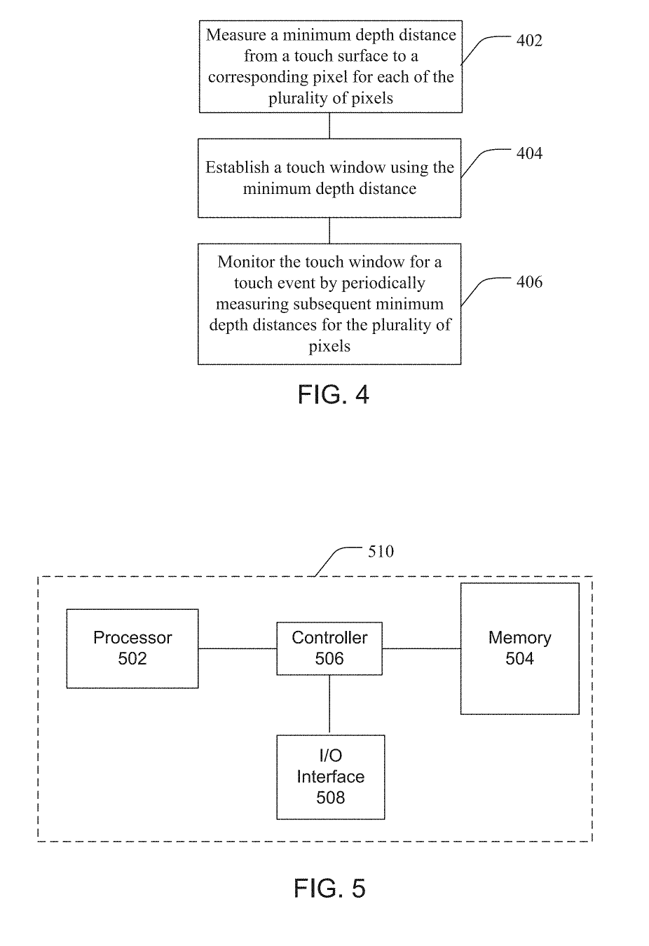

The touch-sensing device 302 also comprises circuitry 308 configured to, as is shown in FIG. 4, 402 measure, using reflected IR light received at the IR imager 306, a minimum depth distance from a touch surface to a corresponding pixel for each of the plurality of pixels, 404 establish a touch window using the minimum depth distance, and 406 monitor the touch window for a touch event by periodically measuring subsequent minimum depth distances for the plurality of pixels.

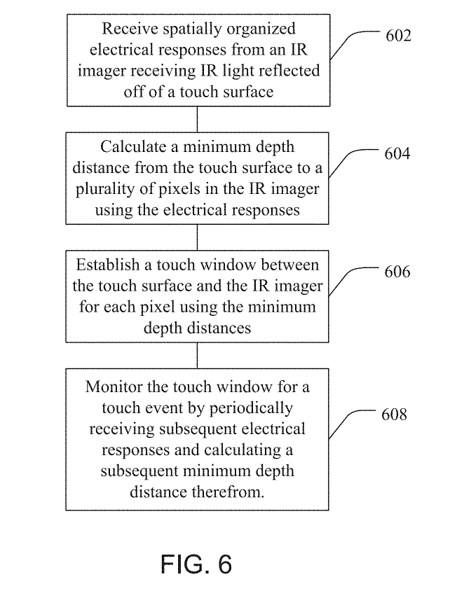

In another example aspect, as is shown in FIG. 5, an electronic device is provided comprising a processor 502, a memory 504, a controller 506 coupled to the processor 502 and to the memory 504, and an input/output (I/O) interface 508 coupled to the controller 506. The device further comprises circuitry 510 that, in conjunction with the aforementioned device elements, is configured to 602 receive, via the I/O interface, spatially organized electrical responses from an IR imager receiving IR light generated by an IR projector and reflected off of a touch surface, 604 calculate, using the processor, a minimum depth distance from the touch surface to a plurality of pixels in the IR imager using the electrical responses, 606 establish a touch window between the touch surface and the IR imager for each pixel using the minimum depth distances, and 608 monitor the touch window for a touch event by periodically receiving subsequent electrical responses and calculating, using the processor, a subsequent minimum depth distance from the touch surface to the plurality of pixels in the IR imager using the subsequent electrical responses. (see FIG. 6).

As has been generally described, IR light reflected off of the touch surface is acquired, and the minimum depth distance from the touch surface to the acquiring IR imager is calculated across the touch surface for a plurality of corresponding pixels within the IR imager. While it is generally beneficial to measure a distance for every pixel in the imager, it is understood that in some cases not every pixel will be utilized. Thus, each point on a surface's geometry (at least for a given pixel pitch) can be characterized as the minimum depth distance value of the distribution of the depth data at that point. By using the minimum depth distance value as a reference point to establish a touch window for each data point, the presence of an object such as a finger entering that window can be interpreted as a contact with the touch surface.

It is understood that various techniques can be used to accomplish the results as described herein, and any such technique is considered to be within the present scope. In one embodiment, for example, the minimum depth distances can be used to establish or otherwise generate a surface characterization (SC) frame as a spatial map of these minimum depth distances across the touch surface. Once established, these minimum depth distance values of the SC frame can be used as reference points to generate the touch window. For example, the touch window can be established for each point in the SC frame by subtracting a minimum window value from each minimum depth distance value to set a lower boundary of the touch window, and by subtracting a maximum window value from each minimum depth distance to set an upper boundary of the touch window. (See, for example, FIG. 2). As such, the SC frame is a representation of the topology of the touch surface as seen by the IR imager. By updating the SC frame over time, changes in the touch surface can be accounted for, such as when a user moves an item on a desk surface, additional items are placed on the touch surface, or the touch surface changes in any other meaningful way. Additionally, updating the SC frame over time can also mitigate various distortion effects, such as imager drift.

In some examples, an initial calibration can be performed to establish accurate minimum depth values for each position in the SC frame. Such an initial calibration phase can comprise, measuring calibration minimum depth distances from the points on the touch surface to the plurality of spatially corresponding pixels of the IR imager using the reflected IR light as described, comparing the calibration minimum depth distances with corresponding minimum depth distances in the SC frame, and replacing minimum depth distances in the SC frame with any calibration minimum depth distance that has a value less than the minimum depth distance stored in the SC frame. This process can be repeated a number of times, until calibration is complete. The number of calibration iterations can vary depending on the system, the preferences of the user, etc. In one example, however, the SC frame can be calibrated for at least 100 iterations. It is additionally noted, that such calibration can continue throughout the use of the device or system, by periodically or continually calibrating in regions of the touch surface where touch events are not occurring.

Various techniques are contemplated to determine when a touch event has occurred. In one non-limiting example, IR light is emitted from the IR projector toward the touch surface, the resultant reflected IR light is measured as an electrical response in the plurality of pixels of the IR imager. A subsequent depth data frame is thus generated from the resulting subsequent minimum depth distances, similar to the generation of the SC frame. Specifically, in one example the subsequent depth data frame can be generated by measuring the subsequent minimum depth distances from the touch surface to the corresponding pixels of the IR imager, whereby subsequent depth data frame is generated as a spatial map of the subsequent minimum depth distances.

Once generated, the subsequent depth data frame can be utilized to detect touch events, or to update or further calibrate the SC frame. For detecting a touch event, in one embodiment subsequent minimum depth distances in the subsequent depth data frame having a value between the lower boundary in the upper boundary of the touch window are identified as touch events. In some cases, it can be beneficial to filter or otherwise process the identified data to eliminate issues relating to noise and the like. Furthermore, in another example, minimum depth distances of the SC frame are compared to spatially corresponding subsequent minimum depth distances of the subsequent characterization frame, and the corresponding locations of the SC frame are updated with any subsequent minimum depth distance that is less than the minimum depth distance currently stored in the SC frame and that is also greater than the lower boundary of the touch window. This effectively updates the calibration of the SC frame in real time during use.

In one specific non-limiting example, a calibration depth data frame is acquired. In one example the frame can be a 2D float array, where each entry is the distance from the IR imager to a point on the touch surface. The entries in the calibration depth data frame are then compared to corresponding entries in the SC frame. In those cases where the calibration entry for a corresponding point is less than the entry in the SC array, the calibration entry replaces the previous entry in the SC frame. For the initial SC frame calibration, the calibration entry is merely copied into the SC frame on the first iteration. In one example, the distance is measured from the imager plane to the surface at each point, and the generated values are the imager's current determination of where the surface is. As values less than the currently stored value are generated, setting the associated array entry to the lower measurement updates the distribution to reflect the closest measurements (highest) between the surface and the imager at each point.

In some examples, a determination can be made as to whether or not the depth data of a given image sensor follows a normal distribution. Once a normal distribution is confirmed, the algorithm can be applied to obtain a sample size large enough to realize the histogram, which may take more or less data points depending on the sensor. The distribution of depth data for the same pixel is normal due, at least in part to, random noise generated by the imager's measurements.

Furthermore, the minimum can be inherently susceptible to extreme outliers. Depending on the imager's distribution, in some cases it can be beneficial to identify and remove outliers that are determined to be outside of the normal distribution as the surface characterization is being generated, as well as during use. As such, in some embodiments, extreme outliers can be removed from the data prior to being added as part of the surface characterization. Any number of calibration iterations can be performed, and is not seen to be limiting. Once the characterization or calibration of the touch surface is complete, each surface point associated with the SC frame contains a minimum recorded value, and the SC frame can be saved in memory as a representation of the touch surface.

Following characterization, an incoming or subsequent depth data frame is acquired, and a determination is made as to whether or not any of the associated entries are within the touch window. For example, if the minimum window value is 3 mm, and the maximum window value is 10 mm, then any entry that has a depth measurement value that is at least 3 mm less than, but no more than 10 mm greater than, the entry in the SC frame, is indicated as a possible touch event. The set of all points within the window can then be saved due to their proximity to the surface. In one example, the set of points can be represented as a bitmap or other image representation.

Once the set of possible touch events is saved, various data manipulation procedures can be implemented, depending on the nature of the data and the preferences of the user. For example, the data can be filtered to remove any noise or other artifacts that affect analysis. In one example, a low-pass filter, such as a boxcar filter, can be applied to remove image noise. Once filtered, the remaining pixels in the bitmap can be identified as point of contact, or in other words, touch events. It is noted, however, that depending on the level of noise, touch events can be identified at any point after depth data has been determined to be within the touch window.

As has been described, data values that fall between the minimum depth value in the SC frame and the lower bound of the touch window can be used to update the entry in the SC frame as a new surface characterization entry. In one example, a lower “characterization found” can be defined as minus 2 mm from the characterized entry this narrow window allows the surface characterization to be updated in real time, without absorbing fingertips into the characterization. At a larger characterization bound (greater than 3 mm, for example), fingertips that rest on a surface for some period of time will be more quickly absorbed into the characterized frame and disappear.

Regarding the minimum and maximum window values used to establish the touch window, numerous values are contemplated, and the touch window can be highly variable depending on the design and intended use of the device or system being implemented. In some cases, for example, it can be desirable to establish a touch window that is narrow and close to the touch surface. In other cases, a touch window situated away from the touch surface may be utilized. In some cases, multiple windows can operate simultaneously to allow interactions on surfaces that have been introduced after the initial calibration, for foreground/background segmentation to be used in applications such as object recognition/tracking, and the like. As such, one or more windows can operate anywhere from the SC value up to the imager plane. In one specific example, the minimum window value can be from 1 mm to 5 mm and the maximum window value can be from 10 mm to 15 mm. In yet another example, the minimum window value can be from 4 mm to 12 mm. In a further example, the width of the touch window is from 4 mm to 12 mm. Additionally, as has been described, the minimum window value can be 5 mm or less, 3 mm or less, 2 mm or less, 1 mm or less, etc. It is noted that, in some cases, the values can be dependent on the imager characteristics, such as accuracy, noise level, and the like. Additionally, the object being detected can influence the window dimensions, including window thickness. For example, in cases where the average human finger is from 5 mm to 10 mm thick, a window of 4 mm to 12 mm may be useful, accounting for noise. It is noted that, while the measurements can be taken from any point on a finger or other object, in one embodiment, the measurements are taken from the top surface.

The presently disclosed techniques can sense a touch event at distances that are very close to the actual touch surface. As one example, a touch event can be sensed at distances of less than or equal to 5 mm, 3 mm, 2 mm, 1 mm, or less. Additionally, such touch events can be sensed on both planar and nonplanar surfaces, and with natural finger movements. As one benefit, the user's finger is not required to be held at a certain angle in order to be sensed. In some cases, however, the flatter a finger is held relative to the surface, the better the accuracy of the distance detection.

As described, the touch surface can have numerous physical configurations, and is not limited to flat planar surfaces. Thus, in addition to planar surfaces, the touch surface can be nonplanar, irregular, as well as highly irregular, including combinations thereof. In one embodiment, the touch surface can be a combination of a planar surface and an irregular surface. For example, a touch surface can be a desktop that includes numerous objects lying there on, such as staplers, writing instruments, tape dispensers, and the like. This is a touch surface where the desktop represents a planar portion, and the objects represent an irregular portion of the overall surface. In one example, the touch surface is a passive surface. In another example, the touch surface is an active surface; however, the device or system does not depend on the utilization of the active properties of the surface in order to operate.

Various IR imagers, IR projectors, and the like, can be used in the realization of devices, systems, and methods of the present disclosure. Any such hardware capable of being used according to the present disclosure is considered to be within the present scope. In one embodiment, a depth camera device such as the Intel RealSense R200, for example, can be used, which includes an IR projector, imagers, and is capable of capturing 3D depth images. In another embodiment, the Intel RealSense SR300 can be used.

The IR source can include any device capable of generating IR light that can be utilized as described. Such sources are well known, and can include devices such as IR LEDs, laser diodes, photonic crystal lasers, solid state lasers, and the like. In one example, the IR source is operable to generate coherent IR light. In another example, such coherent light can include laser radiation from an IR laser. It is additionally contemplated, that a device can include a plurality of IR generating elements. One example can include a Vertical Cavity Surface Emitting Laser (VCSEL). In some cases, a diffuser can be optically coupled to the plurality of IR generating elements. In one embodiment, such a diffuser can be a micro lens array (MLA). Additionally, a diffuser can be optically coupled to single IR source devices.

Furthermore, while IR light has been primarily described, any wavelengths of electromagnetic radiation that can be utilized to derive depth information and that is capable of being incorporated into such a device can be used, and is considered to be within the present scope. In the case of IR light, for example, wavelengths of electromagnetic radiation greater than or equal to 700 nm can be used, although it is additionally contemplated that wavelengths extending down into the visible spectrum can also be utilized as light sources. Furthermore, the light source can generate coherent or non-coherent light, depending on the design of the system. Any type of light, whether coherent or non-coherent, can be utilized provided a projection pattern can be displayed on a surface that can be used to calculate depth information.

The described processor can be a single or multiple processors, and the memory can be a single or multiple memories. A local communication interface can be used as a pathway to facilitate communication between any of a single processor, multiple processors, a single memory, multiple memories, the various interfaces, and the like, in any useful combination.

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In addition to, or alternatively to, volatile memory, in one embodiment, reference to memory devices can refer to a nonvolatile memory device whose state is determinate even if power is interrupted to the device. In one embodiment, the nonvolatile memory device is a block addressable memory device, such as NAND or NOR technologies. Thus, a memory device can also include a future generation nonvolatile devices, such as a three dimensional crosspoint memory device, or other byte addressable nonvolatile memory device. In one embodiment, the memory device can be or include multi-threshold level NAND flash memory, NOR flash memory, single or multi-level Phase Change Memory (PCM), a resistive memory, nanowire memory, ferroelectric transistor random access memory (FeTRAM), magnetoresistive random access memory (MRAM) memory that incorporates memristor technology, or spin transfer torque (STT)-MRAM, or a combination of any of the above, or other memory.

The following examples pertain to specific embodiments and point out specific features, elements, or steps that can be used or otherwise combined in achieving such embodiments.

### EXAMPLES

The following examples pertain to specific embodiments and point out specific features, elements, or steps that can be used or otherwise combined in achieving such embodiments.

In one example there is provided, a touch-sensing device, comprising:

an active infrared (IR) projector;

an IR imager comprising a plurality of pixels positioned to receive reflected IR light from the IR projector; and

circuitry configured to:
measure, using reflected IR light received at the IR imager, a minimum depth distance from a touch surface to a corresponding pixel for each of the plurality of pixels;
establish a touch window using the minimum depth distances;
monitor the touch window for a touch event by periodically measuring subsequent minimum depth distances for the plurality of pixels.

In one example of a touch-sensing device, to establish the touch window, the circuitry is further configured to:
generate a surface characterization (SC) frame as a spatial map of the minimum depth distances; and
establish, using the SC frame, the touch window across the touch surface between the touch surface and the infrared imager.

In one example of a touch-sensing device, to establish the touch window, the circuitry is further configured to:

subtract a minimum window value from each minimum depth distance of the SC frame to set a lower boundary of the touch window; and

subtract a maximum window value from each minimum depth distance of the SC frame to set an upper boundary of the touch window.

In one example of a touch-sensing device, the circuitry is further configured to:

emit IR light from the IR projector toward the touch surface;

generate a subsequent depth data frame from an electrical response of the plurality of pixels to the IR light reflecting from the touch surface.

In one example of a touch-sensing device, to generate the subsequent characterization frame, the circuitry is further configured to:

measure, using the IR light received at the IR imager reflected from the touch surface, subsequent minimum depth distances from the touch surface to the corresponding pixels of the IR imager; and

generate the subsequent depth data frame as a spatial map of the subsequent minimum depth distances.

In one example of a touch-sensing device, to monitor the touch window for a touch event, the circuitry is further configured to identify in the subsequent depth data frame any subsequent minimum depth distances having a value between the lower boundary and the upper boundary of the touch window.

In one example of a touch-sensing device, the circuitry is further configured to:

compare the minimum depth distances of the SC frame to spatially corresponding subsequent minimum depth distances of the subsequent characterization frame; and

update corresponding locations of the SC frame with any subsequent minimum depth distance that is less than the minimum depth distance currently stored in the SC frame and that is greater than the lower boundary of the touch window.

In one example of a touch-sensing device, the minimum window value is from 1 mm to 5 mm and the maximum window value is from 10 mm to 15 mm.

In one example of a touch-sensing device, the minimum window value is from 4 mm to 6 mm.

In one example of a touch-sensing device, the minimum window value is 4 mm and the maximum window value is 12 mm.

In one example of a touch-sensing device, the IR projector is operable to generate coherent IR light.

In one example of a touch-sensing device, the IR projector is an IR laser.

In one example of a touch-sensing device, the IR laser is a laser diode.

In one example of a touch-sensing device, the IR projector further comprises a plurality of IR-generating elements.

In one example of a touch-sensing device, the IR projector is a Vertical Cavity Surface Emitting Laser (VCSEL).

In one example of a touch-sensing device, the device further comprises a diffuser optically coupled to the plurality of IR-generating elements.

In one example of a touch-sensing device, the diffuser is a micro lens array (MLA).

In one example of a touch-sensing device, the device further comprises a diffuser optically coupled to the IR projector.

In one example of a touch-sensing device, the device further comprises a visible light image sensor coupled to the circuitry.

In one example of a touch-sensing device, the IR imager is at least two IR imagers spaced apart from one another.

In one example there is provided, an electronic device, comprising:

a processor;

a memory;

a controller coupled to the processor and to the memory;

an input/output (I/O) interface coupled to the controller; and

circuitry configured to:
receive, via the I/O interface, spatially organized electrical responses from an infrared (IR) imager receiving IR light generated by an IR projector and reflected off of a touch surface;
calculate, using the processor, a minimum depth distance from the touch surface to a plurality of pixels in the IR imager using the electrical responses;
establish a touch window between the touch surface and the IR imager for each pixel using the minimum depth distances;
monitor the touch window for a touch event by periodically receiving subsequent electrical responses and calculating, using the processor, a subsequent minimum depth distance from the touch surface to the plurality of pixels in the IR imager using the subsequent electrical responses.

In one example of an electronic device, to establish the touch window, the circuitry is further configured to:

generate, using the processor, a surface characterization (SC) frame as a spatial map of the minimum depth distances; and

establish, using the SC frame, the touch window across the touch surface between the touch surface and the infrared imager.

In one example of an electronic device, to establish the touch window, the circuitry is further configured to:

subtract a minimum window value from each minimum depth distance of the SC frame to set a lower boundary of the touch window; and

subtract a maximum window value from each minimum depth distance of the SC frame to set an upper boundary of the touch window.

In one example of an electronic device, the circuitry is further configured to:

generate a subsequent depth data frame as a spatial map of subsequent minimum depth distances from the subsequent electrical responses of the plurality of pixels to the IR light reflecting from the touch surface.

In one example of an electronic device, to monitor the touch window for a touch event, the circuitry is further configured to identify in the subsequent depth data frame any subsequent minimum depth distances having a value between the lower boundary and the upper boundary of the touch window.

In one example of an electronic device, the minimum window value is from 1 mm to 5 mm and the maximum window value is from 10 mm to 15 mm.

In one example of an electronic device, the minimum window value is from 4 mm to 6 mm.

In one example of an electronic device, the minimum window value is 4 mm and the maximum window value is 12 mm.

In one example of an electronic device, the circuitry is further configured to:

send IR projector commands from the controller to the IR projector via the I/O interface to regulate emission of IR light; and

send IR imager commands from the controller to the IR imager via the I/O interface to regulate capture of IR light.

In one example there is provided, a method of detecting a touch event on a surface, comprising:

measuring, using reflected infrared (IR) light generated by an IR projector and received at an IR imager, minimum depth distances from points on a touch surface to a plurality of spatially corresponding pixels of the IR imager;

establishing a touch window using the minimum depth distances; and

monitoring the touch window for a touch event by periodically measuring subsequent minimum depth distances for the plurality of pixels.

In one example of a method of detecting a touch event, to establish the touch window, the method further comprises:

generating, using a processor, a surface characterization (SC) frame as a spatial map of the minimum depth distances; and

establishing, using the SC frame, the touch window across the touch surface between the touch surface and the infrared imager.

In one example of a method of detecting a touch event, to establish the touch window, the method further comprises:

subtracting a minimum window value from each minimum depth distance of the SC frame to set a lower boundary of the touch window; and

subtract a maximum window value from each minimum depth distance of the SC frame to set an upper boundary of the touch window.

In one example of a method of detecting a touch event, the method further comprises:

performing an initial calibration phase, comprising:
measuring, using reflected IR light generated by the infrared (IR) projector and received at the IR imager, calibration minimum depth distances from the points on the touch surface to the plurality of spatially corresponding pixels of the IR imager;
comparing the calibration minimum depth distances with corresponding minimum depth distances in the SC frame; and
replacing minimum depth distances in the SC frame with any calibration minimum depth distance that has a value greater than the minimum depth distance stored in the SC frame.

In one example of a method of detecting a touch event, the method further includes:

emitting IR light from the IR projector toward the touch surface;

receiving IR light reflected from the touch surface at the IR imager; and

generating, using an electrical response from the IR imager, a subsequent depth data frame of subsequent minimum depth distances.

In one example of a method of detecting a touch event, to generate the subsequent characterization frame, the method further comprises:

calculating, using the processor and the electrical response from the IR imager, the subsequent minimum depth distances from the touch surface to the corresponding pixels of the IR imager; and

generating, using the processor, the subsequent depth data frame as a spatial map of the subsequent minimum depth distances.

In one example of a method of detecting a touch event, to monitor the touch window for a touch event, the method further comprises:

identifying, in the subsequent depth data frame and using the processor, any subsequent minimum depth distances having a value between the lower boundary and the upper boundary of the touch window.

In one example of a method of detecting a touch event, the method further comprises:

comparing the minimum depth distances of the SC frame to spatially corresponding subsequent minimum depth distances of the subsequent characterization frame; and

updating corresponding locations of the SC frame with any subsequent minimum depth distance that is less than the minimum depth distance currently stored in the SC frame and that is greater than the lower boundary of the touch window.

What is claimed is:

1. A touch-sensing device, comprising:
an active infrared (IR) projector;
an IR imager comprising a plurality of pixels positioned to receive reflected IR light from the IR projector; and
circuitry configured to:
measure, using reflected IR light received at the IR imager, a minimum depth distance from a touch surface to a corresponding pixel for each of the plurality of pixels;
establish a touch window using the minimum depth distances;
monitor the touch window for a touch event by periodically measuring subsequent minimum depth distances for the plurality of pixels.

2. The device of claim 1, wherein to establish the touch window, the circuitry is further configured to:
generate a surface characterization (SC) frame as a spatial map of the minimum depth distances; and
establish, using the SC frame, the touch window across the touch surface between the touch surface and the infrared imager.

3. The device of claim 2, wherein to establish the touch window, the circuitry is further configured to:
subtract a minimum window value from each minimum depth distance of the SC frame to set a lower boundary of the touch window; and
subtract a maximum window value from each minimum depth distance of the SC frame to set an upper boundary of the touch window.

4. The device of claim 3, where the circuitry is further configured to:
emit IR light from the IR projector toward the touch surface;
generate a subsequent depth data frame from an electrical response of the plurality of pixels to the IR light reflecting from the touch surface.

5. The device of claim 4, wherein to generate the subsequent characterization frame, the circuitry is further configured to:
measure, using the IR light received at the IR imager reflected from the touch surface, subsequent minimum depth distances from the touch surface to the corresponding pixels of the IR imager; and
generate the subsequent depth data frame as a spatial map of the subsequent minimum depth distances.

6. The device of claim 5, wherein to monitor the touch window for a touch event, the circuitry is further configured to identify in the subsequent depth data frame any subsequent minimum depth distances having a value between the lower boundary and the upper boundary of the touch window.

7. The device of claim 4, wherein the circuitry is further configured to:
compare the minimum depth distances of the SC frame to spatially corresponding subsequent minimum depth distances of the subsequent characterization frame; and
update corresponding locations of the SC frame with any subsequent minimum depth distance that is less than the minimum depth distance currently stored in the SC frame and that is greater than the lower boundary of the touch window.

8. The device of claim 3, wherein the minimum window value is from 1 mm to 5 mm and the maximum window value is from 10 mm to 15 mm.

9. The device of claim 3, wherein the minimum window value is from 4 mm to 6 mm.

10. The device of claim 3, wherein the minimum window value is 4 mm and the maximum window value is 12 mm.

11. The device of claim 1, wherein the IR projector is operable to generate coherent IR light.

12. The device of claim 11, wherein the IR projector is an IR laser.

13. The device of claim 12, wherein the IR laser is a laser diode.

14. The device of claim 11, wherein the IR projector further comprises a plurality of IR-generating elements.

15. The device of claim 14, wherein the IR projector is a Vertical Cavity Surface Emitting Laser (VCSEL).

16. The device of claim 14, further comprising a diffuser optically coupled to the plurality of IR-generating elements.

17. The device of claim 16, wherein the diffuser is a micro lens array (MLA).

18. The device of claim 11, further comprising a diffuser optically coupled to the IR projector.

19. The device of claim 1, further comprising a visible light image sensor coupled to the circuitry.

20. The device of claim 1, wherein the IR imager is at least two IR imagers spaced apart from one another.

21. A method of detecting a touch event on a surface, comprising:
measuring, using reflected infrared (IR) light generated by an IR projector and received at an IR imager, minimum depth distances from points on a touch surface to a plurality of spatially corresponding pixels of the IR imager;
establishing a touch window using the minimum depth distances; and
monitoring the touch window for a touch event by periodically measuring subsequent minimum depth distances for the plurality of pixels.

22. The method of claim 21, wherein to establish the touch window, the method further comprises:
generating, using a processor, a surface characterization (SC) frame as a spatial map of the minimum depth distances; and
establishing, using the SC frame, the touch window across the touch surface between the touch surface and the infrared imager.

23. The method of claim 22, wherein to establish the touch window, the method further comprises:
subtracting a minimum window value from each minimum depth distance of the SC frame to set a lower boundary of the touch window; and
subtract a maximum window value from each minimum depth distance of the SC frame to set an upper boundary of the touch window.

24. The method of claim 23, further comprising:
performing an initial calibration phase, comprising:
measuring, using reflected IR light generated by the infrared (IR) projector and received at the IR imager, calibration minimum depth distances from the points on the touch surface to the plurality of spatially corresponding pixels of the IR imager;
comparing the calibration minimum depth distances with corresponding minimum depth distances in the SC frame; and
replacing minimum depth distances in the SC frame with any calibration minimum depth distance that has a value greater than the minimum depth distance stored in the SC frame.

25. The method of claim 24, where the method further includes:
emitting IR light from the IR projector toward the touch surface;
receiving IR light reflected from the touch surface at the IR imager; and
generating, using an electrical response from the IR imager, a subsequent depth data frame of subsequent minimum depth distances.
